(19) United States
(12) Patent Application Publication
(10) Pub. No.: US 2024/0359811 A1
(43) Pub. Date: Oct. 31, 2024

(54) AIRCRAFT COMPRISING AT LEAST ONE HYDROGEN SUPPLYING DEVICE FITTED WITH AT LEAST ONE SYSTEM FOR VENTING GAS IN THE EVENT OF A LEAK

(71) Applicant: Airbus Operations SAS, TOULOUSE (FR)

(72) Inventors: Jérôme MILLIERE, TOULOUSE (FR); Lionel CZAPLA, TOULOUSE (FR); Romain JOUBERT, TOULOUSE (FR)

(21) Appl. No.: 18/644,785

(22) Filed: Apr. 24, 2024

(30) Foreign Application Priority Data
Apr. 26, 2023 (FR) 2304181

(51) Int. Cl. B64D 37/30; B64D 37/00; F17C 7/00

(52) U.S. Cl. CPC B64D 37/30; B64D 37/005; F17C 7/00; F17C 2205/0332; F17C 2205/0335; F17C 2205/0355; F17C 2221/012; F17C 2227/0135; F17C 2227/0302; F17C 2265/066; F17C 2270/0189

(57) ABSTRACT

An aircraft comprising at least one secondary structure which separates an inner zone from an outer zone and at least one hydrogen supplying device connecting a hydrogen tank and a motor, and having at least one portion fitted with shut-off valves for isolating it in the event of a leak. The portion has at least one outer enclosure, at least one inner element that is located in the outer enclosure and carries the hydrogen, and at least one interior zone located between the inner element and the outer enclosure, the hydrogen supplying device comprising at least one ventilation system configured to vent gases present in the interior zone toward the outer zone of the secondary structure.

### CROSS-REFERENCES TO RELATED APPLICATIONS

This application claims the benefit of French Patent Application Number 2304181 filed on Apr. 26, 2023, the entire disclosure of which is incorporated herein by way of reference.

### BACKGROUND OF THE INVENTION

The present application relates to an aircraft comprising at least one hydrogen supplying device fitted with at least one system for venting gas in the event of a leak.

According to one embodiment, a hydrogen-powered aircraft comprises at least one hydrogen tank, at least one motor that uses the hydrogen, such as hydrogen-fueled jet engines or electric motors supplied by fuel cells for example, and also, for each motor, at least one hydrogen supplying device connecting the hydrogen tank and the motor.

This hydrogen supplying device comprises a high-pressure pump for pressurizing the hydrogen, a heat exchanger configured to heat the hydrogen, and various hydrogen pipelines for connecting the hydrogen tank, the pump, the heat exchanger and the motor.

According to one embodiment, the hydrogen is carried in double-wall pipelines each comprising an outer pipe and an inner pipe positioned inside the outer pipe.

During operation, the interior zone between the inner and outer pipes exhibits a high level of vacuum or contains an inert gas to isolate the hydrogen carried in the inner pipe from the air located outside the outer pipe. As illustrated in document FR3127543, each hydrogen pipeline comprises at least one pressure sensor configured to measure a pressure in the interior zone, an increase in pressure in the interior zone corresponding to a probable hydrogen or oxygen leak, and a hydrogen sensor configured to detect the presence of hydrogen in the interior zone.

The hydrogen supplying device also comprises at least one vessel which separates an interior zone and an exterior zone in gastight fashion, the high-pressure pump and/or the heat exchanger being located in the interior zone of the vessel. The latter has at least one hydrogen sensor configured to detect the presence of hydrogen in the interior zone or a pressure sensor configured to measure a pressure in the interior zone, an increase in pressure in the interior zone possibly being indicative of a hydrogen or oxygen leak. During operation, the interior zone contains an inert gas or exhibits a high level of vacuum. As a result, in the event of a hydrogen leak in the interior zone, the hydrogen is not in contact with the ambient air located in the exterior zone of the vessel.

The hydrogen supplying device also comprises multiple shut-off valves for segmenting it into multiple portions.

The hydrogen sensors or the pressure sensors make it possible to detect a hydrogen leak in an interior zone of a vessel or a pipeline in one portion and to isolate it from the rest of the hydrogen supplying device by causing the shut-off valves positioned at the ends of the portion in which the leak has been detected to close.

This solution makes it possible to obtain a safe hydrogen supplying device in so far as hydrogen is no longer supplied to the portion which exhibits a hydrogen leak and the hydrogen that has leaked is contained in a vessel and/or in an outer pipe of a pipeline and is not in contact with the ambient air.

### SUMMARY OF THE INVENTION

The present invention aims to enhance the safety of a hydrogen supplying device of an aircraft.

To that end, the invention relates to an aircraft comprising:
at least one secondary structure separating an inner zone from an outer zone,
at least one motor that uses the hydrogen located in the inner zone of the secondary structure,
at least one hydrogen tank, and
at least one hydrogen supplying device connecting the hydrogen tank and the motor,

the hydrogen supplying device comprising:
at least one portion having at least one outer enclosure that is at least one outer pipe or at least one vessel,
first and second shut-off valves configured to isolate said portion in the event of a leak,
at least one inner element, located in the outer enclosure and carrying the hydrogen, that is notably at least one inner pipe, at least one pump, at least one heat exchanger or at least one shut-off valve, at least one interior zone being located between the inner element and the outer enclosure,
at least one ventilation system configured to vent a gas present in the inner zone toward the outer zone of the secondary structure,
the vessel delimiting the interior zone and having a cylindrical tubular body, and
at least one injection system for injecting an inert gas into the interior zone, comprising at least:
   one inert gas tank,
   one injection pipe connecting the inert gas tank and the interior zone,
   one regulation system for controlling a flow of the inert gas in the injection pipe, and
   one diffuser which is connected to the inert gas tank, is positioned in the vessel and is substantially coaxial with the cylindrical tubular body.

The ventilation system makes it possible to vent the hydrogen present in the inner zone in the event of a leak in order to reduce its concentration. Consequently, even if the vessel or the outer pipe delimiting the interior zone in which the hydrogen has leaked owing to a first leak is no longer leaktight and leaks, the risks of incidents owing to a second hydrogen leak in the inner zone of the secondary structure are reduced.

According to another feature, the ventilation system comprises at least one ventilation pipe which has at least one inlet leading into the interior zone and an outlet leading into the outer zone of the secondary structure, and at least one ventilation valve configured to occupy an open state, in which the ventilation valve allows a gas to leave the interior zone, and a closed state, in which it prevents a gas from leaving said interior chamber.

According to one embodiment, the ventilation valve is an autonomous ventilation valve configured to change state autonomously and occupy a closed state when the interior zone exhibits a pressure less than a given threshold and an open state when the interior zone exhibits a pressure greater than or equal to the given threshold.

According to one embodiment, the ventilation valve is a ventilation valve that can be controlled by a remote element.

According to another feature, the hydrogen supplying device comprises:
at least one double-wall pipeline having an inner pipe, an outer pipe positioned around the inner pipe and an interior zone located between the inner and outer pipes,
at least one vessel which delimits an interior zone and in which at least one inner element is positioned.

In addition, the ventilation system comprises an inlet, which leads into the interior zone of each double-wall pipeline and at which an autonomous ventilation valve is positioned, and first and second inlets leading into the interior zone of each vessel, an autonomous ventilation valve being positioned at the first inlet, a controllable ventilation valve being positioned at the second inlet.

According to another feature, the ventilation system comprises at least one extractor positioned in the ventilation pipe and configured to generate a stream of gas toward the outlet.

According to another feature, the regulation system has at least one controlled valve arranged on the injection circuit and configured to permit the flow of inert gas into the injection pipe from the inert gas tank.

According to another feature, the diffuser has an annular tube, which is connected to the inert gas tank, is positioned in the vessel and is substantially coaxial with the cylindrical tubular body, and also multiple injectors distributed around the circumference of the annular tube.

According to one configuration, the injectors are configured to inject the inert gas along directions forming a given angle with the axis of revolution of the annular tube so as to obtain a stream swirling around the axis of revolution of the annular tube, inside the vessel.

According to another configuration, the injectors are configured to inject the inert gas along a direction parallel to the axis of revolution of the annular tube.

According to another configuration, the hydrogen supplying device comprises a vessel delimiting the interior zone and having a cylindrical tubular body; the injection system comprising at least one diffuser having a body of conical overall shape, which is connected to the inert gas tank, is positioned in the vessel and is substantially coaxial with the cylindrical tubular body, and also multiple fins distributed around the circumference of the body.

According to another feature, the hydrogen supplying device comprises at least one pressure relief pipe, which has a first end leading into an inner pipe that carries the hydrogen and a second end leading into the ventilation pipe, and a pressure relief valve positioned at the pressure relief pipe and configured to occupy a closed state when the hydrogen in the inner pipe exhibits a pressure less than or equal to the given threshold and an open state when the hydrogen in the inner pipe exhibits a pressure greater than a given threshold.

### BRIEF DESCRIPTION OF THE DRAWINGS

Other features and advantages will become apparent from the following description of the invention, the description being given solely by way of example, with reference to the appended drawings, in which:

FIG. 1 is a perspective view of an aircraft,

FIG. 2 is a schematic representation of a hydrogen tank, a propulsion assembly and a hydrogen supplying device, illustrating one embodiment of the invention,

FIG. 3 is a schematic representation of a hydrogen supplying device, illustrating one embodiment of the invention,

FIG. 4 is a schematic representation of a hydrogen tank, a propulsion assembly and a hydrogen supplying device, illustrating one embodiment of the invention,

FIG. 5 is a schematic representation of a hydrogen tank, a propulsion assembly and a hydrogen supplying device, illustrating another embodiment of the invention,

FIG. 6 is a perspective view of a part of a propulsion assembly, illustrating one embodiment of the invention,

FIG. 7 is a perspective view of a part of a hydrogen supplying device, illustrating one embodiment of the invention,

FIG. 8 is a perspective view of a part of a hydrogen supplying device, illustrating another embodiment of the invention,

FIG. 9 is a perspective view of a vessel of a hydrogen supplying device, illustrating one embodiment of the invention,

FIG. 10 is a perspective view of a diffuser of an injection system for injecting an inert gas, illustrating one embodiment of the invention,

FIG. 11 is a perspective view of a diffuser of an injection system for injecting an inert gas, illustrating another embodiment of the invention,

FIG. 12 is a front view of a diffuser of an injection system for injecting an inert gas, illustrating another embodiment of the invention, and

FIG. 13 is a side view of a diffuser of an injection system for injecting an inert gas, illustrating another embodiment of the invention.

### DETAILED DESCRIPTION OF THE PREFERRED EMBODIMENTS

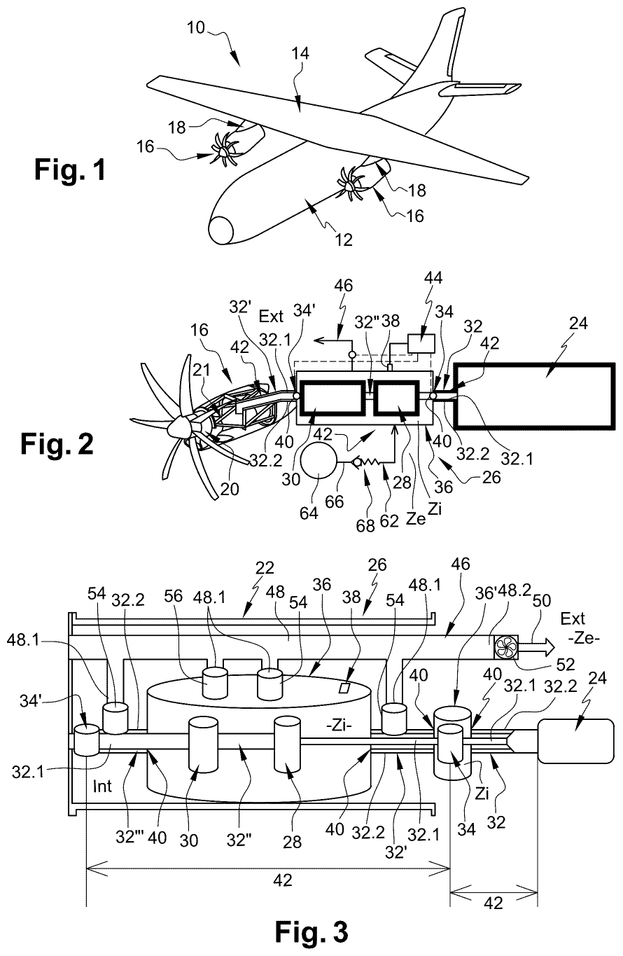

According to an embodiment that can be seen in FIG. 1, an aircraft 10 comprises a fuselage 12, a wing 14 and propulsion assemblies 16 positioned below the wing 14 and each connected to the latter by a pylon 18.

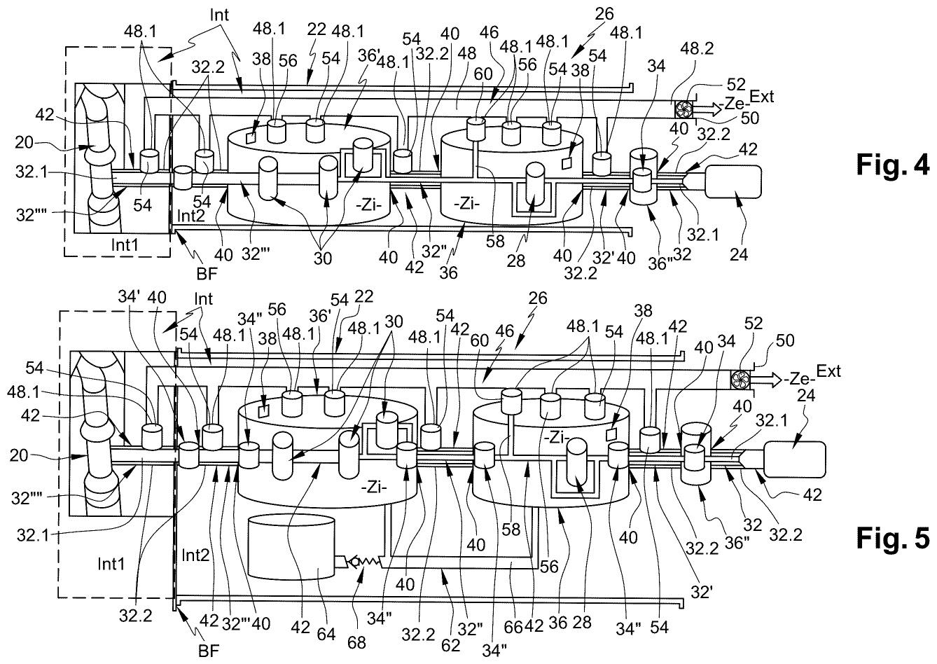

As illustrated in FIG. 2, the propulsion assembly 16 comprises a motor 20 that uses the hydrogen, such as a hydrogen-fueled jet engine or an electric motor supplied by fuel cells, for example. The propulsion assembly 16 also comprises a primary structure 21 supporting the motor 20 and a secondary structure 22 which forms a fairing and separates an inner zone Int from an outer zone Ext (the zones can be seen in FIGS. 4 and 5), the primary structure 21 and the motor 20 being located in the inner zone Int. According to one configuration, the inner zone comprises a fire barrier BF dividing the inner zone Int into a first inner zone Int1 (referred to as fire zone) containing the motor 20 and a second inner zone Int2.

The aircraft 10 comprises at least one hydrogen tank 24 positioned in the fuselage 12 and/or the wing 14 and, for each propulsion assembly 16, at least one hydrogen supplying device 26 connecting the hydrogen tank 24 and the motor 20. The hydrogen supplying device 26 is positioned at least partially in the inner zone Int of the secondary structure 22.

According to an embodiment that can be seen in FIG. 2, the hydrogen supplying device 26 comprises at least one pump 28 for pressurizing the hydrogen, at least one heat exchanger 30 configured to heat the hydrogen, and pipelines 32 connecting the hydrogen tank 24, the pump 28, the heat exchanger 30 and the motor 20. The hydrogen supplying device 26 comprises shut-off valves 34 each configured to alternately occupy a closed state and an open state. The hydrogen supplying device 26 also comprises at least one vessel 36, which separates, in gastight fashion, an interior zone Zi from an exterior zone, and at least one inner element, positioned in the interior zone Zi, that is notably at least one pump 28, at least one heat exchanger 30, at least one pipeline 32 or at least one shut-off valve 34.

According to one configuration, at least one vessel 36 comprises at least one sensor 38 configured to detect a hydrogen leak in the interior zone Zi. The sensor 38 may be a hydrogen sensor configured to detect the presence of hydrogen in the interior zone Zi or a pressure sensor configured to detect an increase in pressure in the interior zone Zi corresponding to a probable hydrogen leak or a sensor configured to detect the activation of a venting system for venting the overpressure from the vessel 36. The interior zone Zi contains an inert gas, such as helium or nitrogen, and/or exhibits a high level of vacuum.

According to one configuration, at least one pipeline 32 is a double-wall pipeline and comprises an inner pipe 32.1, an outer pipe 32.2 positioned around the inner pipe 32.1 and an interior zone Zi between the inner and outer pipes 32.1, 32.2. According to one configuration, the interior zone Zi provided between the inner and outer pipes 32.1, 32.2 contains an inert gas, such as helium or nitrogen for example, or exhibits a high level of vacuum. At least one pipeline 32 comprises at least one sensor configured to detect a hydrogen leak in the interior zone Zi. The sensor may be a hydrogen sensor configured to detect the presence of hydrogen in the interior zone Zi provided between the inner and outer pipes 32.1, 32.2 or a pressure sensor configured to detect an increase in pressure in the interior zone Zi provided between the inner and outer pipes 32.1, 32.2 corresponding to a probable hydrogen leak or a sensor configured to detect the activation of a venting system for venting the overpressure from the pipeline 32.

In one arrangement, a pipeline 32 comprises a first part located in the interior zone Zi of a vessel 36 and a second part located in the exterior zone of the vessel 36. The first part of the pipeline may comprise only a single inner pipe 32.1. The second part of the pipeline 32 is a double-wall pipeline. In addition, the vessel 36 comprises an orifice for allowing the inner pipe 32.1 of the pipeline 32 to pass through the vessel and a connection system 40 connecting the outer pipe 32.2 and the vessel 36 in gastight fashion.

According to an embodiment that can be seen in FIG. 2, the hydrogen supplying device 26 comprises a vessel 36 in which the pump 28 and the heat exchanger 30 are positioned, with a first pipeline 32 connecting the hydrogen tank 24 and the pump 28, a second pipeline 32′ connecting the heat exchanger 30 and the motor 20, and a third pipeline 32″ connecting the pump 28 and the heat exchanger 30. The first pipeline 32 has an outer pipe 32.2 connected to the vessel 36 by a gastight connection system 40 at which a first shut-off valve 34 is positioned. The second pipeline 32′ has an outer pipe 32.2 connected to the vessel 36 by a connection system 40 at which a second shut-off valve 34′ is positioned.

According to another embodiment that can be seen in FIG. 3, the hydrogen

supplying device 26 comprises a first vessel 36 in which the pump 28 and the heat exchanger 30 are positioned, a second vessel 36′ in which a first shut-off valve 34 is positioned, a first pipeline 32 connecting the hydrogen tank 24 and the first shut-off valve 34, a second pipeline 32′ connecting the first shut-off valve 34 and the pump 28, a third pipeline 32″ connecting the pump 28 and the heat exchanger 30, a fourth pipeline 32′″ connecting the heat exchanger 30 and the motor 20 and a second shut-off valve 34′ located at the fourth pipeline 32′″. The first pipeline 32 has an outer pipe 32.2 connected to the second vessel 36′ by a gastight connection system 40. The second pipeline 32′ has an outer pipe 32.2 connected to the first vessel 36 and to the second vessel 36′ by gastight connection systems 40. The fourth pipeline 32′″ has an outer pipe 32.2 connected to the first vessel 36 by a gastight connection system 40. The third pipeline 32″, integrally located in the first vessel 36, may comprise only a single inner pipe.

According to other embodiments that can be seen in FIGS. 4 and 5, the hydrogen supplying device 26 comprises a first vessel 36 in which at least one pump 28 is positioned, a second vessel 36″ in which at least one heat exchanger 30 is positioned, a third vessel 36″ in which a first shut-off valve 34 is positioned, a first pipeline 32 connecting the hydrogen tank 24 and the first shut-off valve 34, a second pipeline 32′ connecting the first shut-off valve 34 and the pump 28, a third pipeline 32″ connecting the pump 28 and the heat exchanger 30, a fourth pipeline 32′″ connecting the heat exchanger and a second shut-off valve 34′, and a fifth pipeline 32″″ connecting the second shut-off valve 34′ and the motor 20. The first pipeline 32 has an outer pipe 32.2 connected to the third vessel 36″ by a gastight connection system 40. The second pipeline 32′ has an outer pipe 32.2 connected to the first vessel 36 and to the third vessel 36″ by gastight connection systems 40. The third pipeline 32″ has an outer pipe 32.2 connecting the first and second vessels 36, 36′ via gastight connection systems 40. The fourth pipeline 32′″ has an outer pipe 32.2 connected to the second vessel 36′ by a gastight connection system 40. Lastly, the fifth pipeline 32″″ comprises an outer pipe 32.2.

According to the embodiment that can be seen in FIG. 5, the hydrogen supplying device 26 comprises a shut-off valve 34″ at each connection system 40 connecting an outer pipe of a pipeline and the first or second vessel 36, 36′.

Of course, the invention is not limited to these embodiments for the hydrogen supplying device 26.

Irrespective of the embodiment, the hydrogen supplying device 26 comprises at least one portion 42 which extends between first and second ends and first and second shut-off valves 34, 34′ which are provided at the first and second ends, respectively, of the portion 42 and are configured to each alternately occupy open and closed states. In one arrangement, the portion 42 is positioned in the inner zone Int of the secondary structure 22.

The portion 42 comprises at least one outer enclosure that is at least one outer pipe 32.2 and at least one vessel 36, at least one inner element, located in the outer enclosure and carrying the hydrogen, that is notably at least one inner pipe 32.1, at least one pump 28, at least one heat exchanger 30 or at least one shut-off valve 34, and at least one interior zone Zi located between the inner element and the outer enclosure. The first and second shut-off valves 34, 34′ are configured to switch to the closed state when hydrogen is detected in the inner zone Zi.

According to the embodiment that can be seen in FIG. 2, the hydrogen supplying device 26 comprises three portions 42, namely a first portion 42 having the first pipeline 32, a second portion 42 having the vessel 36 in which the pump 28 and the heat exchanger 30 are positioned, and a third portion 42 having the second pipeline 32′.

According to the embodiment that can be seen in FIG. 3, the hydrogen supplying device 26 comprises two portions 42, namely a first portion 42 having the first pipeline 32 and a second portion 42 having the vessel 36 and the second and third pipelines 32′, 32″.

According to the embodiment that can be seen in FIG. 4, the hydrogen supplying device 26 comprises three portions 42, namely a first portion 42 having the first pipeline 32, a second portion 42 having the first and second vessels 36, 36′ and the second, third and fourth pipelines 32′, 32″, 32′″, and a third portion 42 having the fifth pipeline 32″″. In one arrangement, the first portion 42 is located in the fuselage 12 and/or the wing 14. The second portion 42 is located in the second inner zone Int2 present in the secondary structure 22. The third portion 42 is located in the first inner zone Int1.

According to the embodiment that can be seen in FIG. 5, the hydrogen supplying device 26 comprises seven portions 42, each having a pipeline 32, 32′, 32″, 32′″, 32″″ or a vessel 36, 36′, 36″.

The hydrogen supplying device 26 comprises at least one sensor 38 configured to detect the presence of hydrogen in at least one interior zone Zi of at least one portion 42. The sensor 38 may be a hydrogen sensor configured to detect the presence of hydrogen in the interior zone Zi of at least one portion 42 or a pressure sensor configured to detect an increase in pressure in the interior zone Zi of at least one portion 42 corresponding to a probable hydrogen leak or a sensor configured to detect the activation of a venting system for venting the overpressure from the portion 42. According to one configuration, the hydrogen supplying device 26 comprises at least one sensor 38 for each interior zone Zi of each portion 42.

The hydrogen supplying device 26 also comprises at least one controller 44 configured to control the state of the first and second shut-off valves 34, 34′, 34″ of at least one portion 42 in order to isolate said portion from the rest of the hydrogen supplying device 26. According to one configuration, the controller 44 is configured to control the first and second shut-off valves 34, 34′, 34″ of all the portions 42.

According to one particular feature, the hydrogen supplying device 26 comprises at least one ventilation system 46 configured to vent a gas present in at least one interior zone Zi of at least one portion 42 toward the outer zone Ext of the secondary structure 22 in the event of detection of a hydrogen leak in said interior zone Zi. For the present application, a gas is understood to mean both a gas and a mixture of gases.

According to one embodiment, the ventilation system 46 comprises at least one ventilation pipe 48 having at least one inlet 48.1 leading into the interior zone Zi of at least one portion 42 and an outlet 48.2 leading into the outer zone Ext of the secondary structure 22 via an opening 50 which passes through the secondary structure 22. According to one embodiment, the ventilation system 46 comprises a ventilation pipe 48 having multiple inlets 48.1, at least one for each interior zone Zi of each portion 42, and an outlet 48.2 leading into the outer zone Ext of the secondary structure 22 via an opening 50 which passes through the secondary structure 22. According to one embodiment, the opening 50 is dedicated to the ventilation system 46. According to another embodiment, the opening 50 is an opening shared by the ventilation system 46 and another system of the propulsion assembly 16.

According to an optional configuration, the ventilation system 46 comprises at least one extractor 52, positioned in the ventilation pipe 48 and configured to generate a stream of gas from each interior zone Zi toward the outlet 48.2, promoting the discharge of the gas present in each interior zone Zi of each portion 42. In a nonlimiting arrangement, the ventilation system 46 comprises a single extractor 52 positioned at the outlet 48.2. Of course, other arrangements of the extractor 52 are possible and the ventilation system 46 may comprise multiple extractors 52 positioned at various locations.

The ventilation system 46 comprises at least one ventilation valve 54, 56 configured to occupy an open state in which the ventilation valve 54, 56 allows a gas to leave the interior zone Zi connected to said ventilation valve 54, 56 and a closed state in which the ventilation valve 54, 56 prevents a gas from leaving or entering said interior chamber Zi. In one arrangement, the ventilation system 46 comprises a ventilation valve 54, 56 at each inlet 48.1.

According to one configuration, the ventilation valve 54 is an autonomous ventilation valve configured to change state autonomously. According to this configuration, the autonomous ventilation valve 54 is a pressure limiting valve configured to occupy a closed state when the interior zone Zi exhibits a pressure less than a given threshold and an open state when the interior zone Zi exhibits a pressure greater than or equal to the given threshold. According to one mode of operation, if the autonomous ventilation valve 54 is a pressure limiting valve, it can, like the sensor 38, perform the function of detecting a hydrogen leak in the interior zone Zi connected to the ventilation valve 54, the change of state from the closed state to the open state corresponding to hydrogen being detected in the interior zone Zi. Specifically, the ventilation valve 54 will detect an increase in pressure owing to a hydrogen leak in the interior zone Zi and deduce the presence of hydrogen in the interior zone Zi from this.

According to another configuration, the ventilation valve 56 is a ventilation valve that can be controlled by a remote element like the controller 44.

According to one embodiment, the ventilation system 46 comprises an inlet 48.1 which leads into the interior zone Zi of each double-wall pipeline 32 (located between the inner pipe 32.1 and the outer pipe 32.2 of said pipeline 32) and at which an autonomous ventilation valve 54, like a pressure limiting valve, is positioned, and first and second inlets 48.1 leading into the interior zone Zi of each vessel 36 in which at least one element from among the pump 28 and the heat exchanger 30 is positioned, an autonomous ventilation valve 54, like a pressure limiting valve, being positioned at the first inlet 48.1, a controllable ventilation valve 54 being positioned at the second inlet 48.1. The function of the ventilation valve 54 is to automatically vent the overpressure from the vessel 36. In a variant of the ventilation valve 54, a burst disk may be used. This burst disk is configured to open up the passage at a predetermined pressure by rupturing. According to one configuration, the ventilation system has an autonomous ventilation valve and a burst disk configured to activate if the autonomous ventilation valve malfunctions.

According to an embodiment that can be seen in FIG. 5, the hydrogen supplying device 26 comprises at least one pressure relief pipe 58, which has a first end leading into the inner pipe 32.1 of one of the pipelines 32 of the hydrogen supplying device 26, notably that leaving the pump 28, and a second end leading into the ventilation pipe 48, and an autonomous pressure relief valve 60, like a pressure limiting valve for example, positioned at the pressure relief pipe 58 and configured to occupy an open state when the hydrogen in the inner pipe 32.1 exhibits a pressure greater than a given threshold and a closed state when the hydrogen in the inner pipe 32.1 exhibits a pressure less than or equal to the given threshold.

According to the embodiments that can be seen in FIGS. 2 and 5, the hydrogen supplying device 26 comprises at least one injection system 62 for injecting an inert gas into at least one interior zone Zi of at least one portion 42, notably into the interior zone Zi of at least one vessel 36. In an arrangement that can be seen in FIG. 5, the injection system 62 is configured to inject an inert gas into the interior zone Zi of each vessel 36. This injection system 62 promotes the venting of hydrogen from the zone Zi of each vessel 36 in the event of a leak.

Depending on the circumstances, the inert gas may be helium or nitrogen. Of course, the invention is not limited to this type of inert gas.

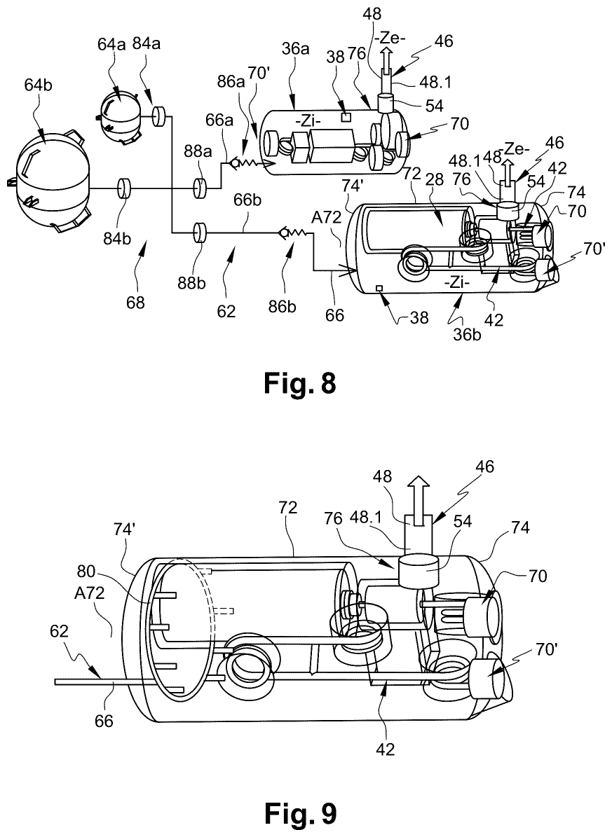

According to one embodiment, the injection system 62 comprises at least one inert gas tank 64 (a single inert gas tank 64 is shown in FIG. 7, whereas two inert gas tanks 64 are shown in FIG. 8) and at least one injection pipe 66 connecting the inert gas tank 64 and an interior zone Zi (a single injection pipe 66 is shown in FIG. 7, whereas two injection pipes 66 are shown in FIG. 8). An injection pipe 66 is configured to lead into each interior zone Zi in which an inert gas is to be injected.

According to one configuration, the injection system 62 comprises multiple inert gas tanks 64, each being connected to each interior zone Zi in which an inert gas is to be injected via an injection pipe 66.

According to one embodiment, each inert gas tank 64 is configured to store the inert gas in the pressurized state. The inert gas is stored in the inert gas tank at a pressure greater than the pressure of the interior zone Zi.

The injection system 62 comprises a regulation system 68 for controlling the flow of the inert gas from at least one inert gas tank 64 into at least one injection pipe 66.

According to a configuration shown in FIG. 7, the injection system 62 has an inert gas tank 64 and an injection pipe 66 for fluidically connecting the inert gas tank 64 to the interior zone Zi. The regulation system 68 has a controlled valve 84 arranged on the injection pipe 66 and configured to make it possible to open the inert gas tank 64. More specifically, the valve 84 is configured to occupy a closed state in the absence of a command signal and occupy an open state that activates the injection system 62 for injecting inert gas from the inert gas tank 64 to the interior zone Zi upon reception of a command signal. The pressure in the inert gas tank 64 is high enough for the inert gas to be delivered to the injection pipe 66 after the valve 84 has been opened, without needing the pump.

According to one embodiment, each regulation system 68 also has a non-return valve 86 configured to occupy a closed state when the interior zone Zi exhibits a pressure greater than that of the inert gas stored in the inert gas tank 64 connected to the interior zone Zi and an open state when the interior zone Zi exhibits a pressure less than or equal to that of the inert gas stored in the inert gas tank 64 connected to the interior zone Zi. Specifically, in the event of a hydrogen leak, after the valve 84 for delivering the inert gas from the pressurized inert gas tank 64 to the interior zone Zi has been activated, the pressure in this interior zone Zi increases, whereas the pressure in the inert gas tank 64 decreases as the inert gas 64 passes from the inert gas tank 64 to the interior zone Zi. The non-return valve 86 makes it possible to prevent the inert gas returning to the inert gas tank 64 once the pressures of the inert gas tank 64 and the gas-filled interior zone Zi are balanced.

According to a configuration shown in FIG. 8, the hydrogen supplying device 26 comprises multiple vessels 36a, 36b (two of which are shown in FIG. 8) which separate, in gastight fashion, an interior zone Zi from an exterior zone. The injection system 62 has multiple inert gas tanks 64a, 64b (two of which are shown in FIG. 8) and an injection pipe 66a, 66b for connecting each inert gas tank 64 to the interior zone Zi of a vessel 36a, 36b. The injection pipes 66a, 66b are interconnected such that each inert gas tank 64a, 64b is connected to the interior zone Zi of each vessel 36a, 36b. At the outlet of each inert gas tank 64a, 64b, the regulation system 68 has a controlled valve 84a, 84b in order to control the opening of said inert gas tank 64a, 64b. On each injection pipe 66a, 66b, the regulation system 68 has a controlled valve 88a, 88b in order to control the filling of the vessel 36a, 36b with inert gas.

If a hydrogen leak is detected in the vessel 36a, a command signal will be sent to the valve 88a to change from its closed state to its open state, whereas the valve 88b will remain in its closed state so that the vessel 36b is not filled with inert gas. Then, a command signal will be sent to the valve 84b to change from its closed state to its open state so that the inert gas from the inert gas tank 64b fills the vessel 36a, whereas the valve 84a will remain in its closed state. As an alternative, a command signal may also be sent to the valve 84a to change from its closed state to its open state so that the inert gas from the inert gas tank 64b also fills the vessel 36a.

The regulation system 68 also has a non-return valve 86a, 86b arranged on each injection pipe 66a, 66b and configured to occupy a closed state when the interior zone Zi of the vessel 36a, 36b exhibits a pressure greater than that of the inert gas stored in one of the inert gas tanks 64a, 64b which is fluidically connected to the interior zone Zi of said vessel 36a, 36b and an open state when the interior zone Zi of said vessel 36a, 36b exhibits a pressure less than or equal to that of the inert gas stored in one of the inert gas tanks 64a, 64b fluidically connected to said interior zone Zi. Specifically, in the event of a hydrogen leak, the non-return valve 86a, 86b makes it possible to prevent the inert gas from returning to the inert gas tank 64a, 64b once the pressures of the inert gas tank 64a, 64b and the gas-filled interior zone Zi are balanced.

According to a configuration which is not shown, the hydrogen supplying device 26 comprises multiple vessels 36a, 36b which separate, in gastight fashion, an interior zone Zi from an exterior zone and the injection system 62 has a single inert gas tank 64 and an injection pipe 66a, 66b for connecting the inert gas tank 64 to the interior zone Zi of each vessel 36a, 36b. The injection pipes 66a, 66b are interconnected such that the inert gas tank 64 is connected to the interior zone Zi of each vessel 36a, 36b. On each injection pipe 66a, 66b, the regulation system 68 has a controlled valve 88a, 88b in order to activate and control the filling of the vessel 36a, 36b with inert gas. If a hydrogen leak is detected in the vessel 36a, a command signal is sent to the valve 88a to change from its closed state to its open state, and this will make it possible to open the inert gas tank 64 and fill the vessel 36a with inert gas, whereas the valve 88b remains in its closed state so that the vessel 36b is not filled with inert gas.

According to a configuration which is not shown, the hydrogen supplying device 26 comprises a single vessel 36 which separates, in gastight fashion, an interior zone Zi from an exterior zone and the injection system 62 has multiple inert gas tanks 64a, 64b and an injection pipe 66 for connecting the inert gas tanks 64a, 64b to the interior zone Zi of said vessel 36. At the outlet of each inert gas tank 64a, 64b, the regulation system 68 has a controlled valve 84a, 84b in order to control the opening of said inert gas tank 64a, 64b. If a hydrogen leak is detected in the vessel 36, a command signal is sent to one of the valves 88a, 88b to change from its closed state to its open state, whereas the other one of the valves 88a, 88b remains in its closed state.

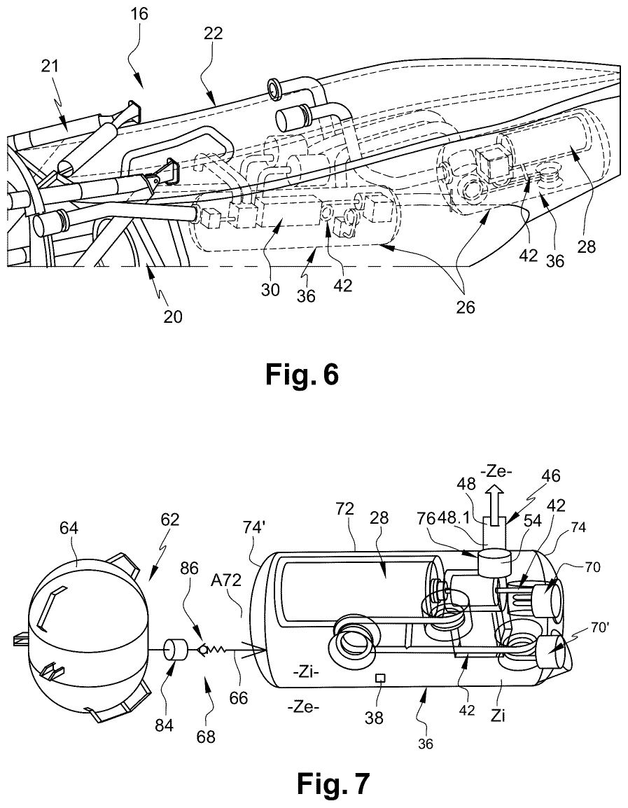

According to an embodiment that can be seen in FIG. 6, the propulsion assembly 16 comprises, in addition to the motor 20 and the secondary structure 22, multiple vessels 36 in each of which is positioned a portion 42 of the hydrogen supplying device 26, said portion 42 having at least one inner element that is notably at least one pump 28 or at least one heat exchanger 30.

As illustrated in FIG. 7, each vessel 36 comprises inlet and outlet connections 70, 70′ for connecting the portion 42 to the other portions of the hydrogen supplying device 26, each of the inlet and outlet connections 70, 70′ having a shut-off valve 34, 34′, 34″.

According to one embodiment, each vessel 36 has a cylindrical tubular body 72 which has an axis of revolution A72 and extends between first and second ends, and first and second hemispherical domes 74, 74′ which shut off the first and second ends of the cylindrical tubular body 72 in leaktight fashion.

In one arrangement, the inlet and outlet connections 70, 70′ are positioned at the first dome 74. In another arrangement, the inlet connection 70 is positioned at the first dome 74 and the outlet second connection 70′ is positioned at the second dome 74′.

According to one embodiment, each vessel 36 comprises at least one outlet 76, positioned at the cylindrical tubular body 72, for connecting the interior zone Zi of the vessel 36 to a ventilation pipe 48, a ventilation valve 54, 56 being positioned at the outlet 76. According to one configuration, each vessel 36 comprises a first outlet 76 at which an autonomous ventilation valve 54, like a pressure limiting valve for example, is positioned, and a second outlet 76 at which a controllable ventilation valve 56 is positioned.

According to a configuration that can be seen in FIG. 9, the injection system 62 comprises at least one diffuser 78 which is positioned in the vessel 36, is connected to at least one inert gas tank 64, and is configured to generate a swirling stream in the vessel 36. According to one embodiment, the diffuser 78 comprises an annular tube 80 connected to at least one inert gas tank 64 and multiple injectors 82 distributed around the circumference of the annular tube 80. The annular tube 80 has an axis of revolution A80. In one arrangement, the annular tube 80 is substantially (i.e., +/−10%) coaxial with the cylindrical tubular body 72 of the vessel 36.

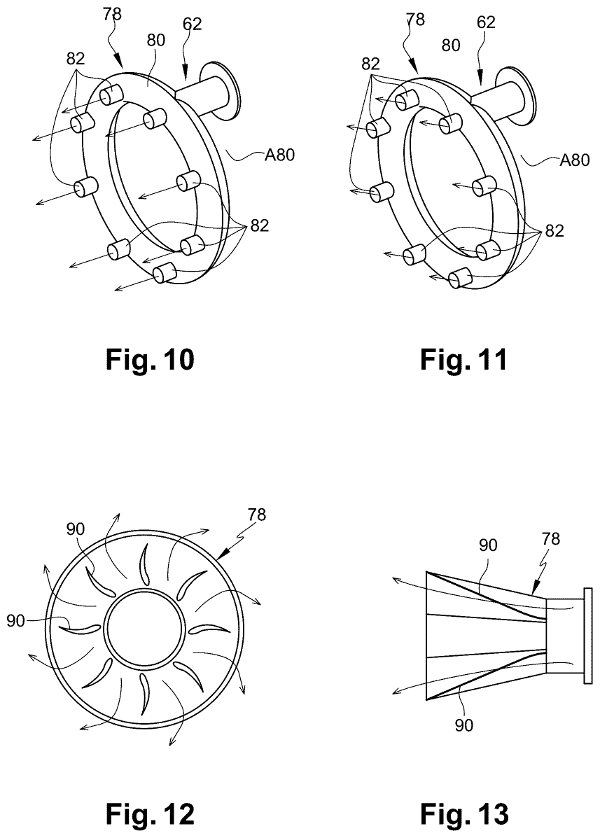

According to a first variant that can be seen in FIG. 10, the injectors 82 are configured to inject the inert gas along a direction parallel to the axis of revolution A80 of the annular tube 80.

According to a second variant that can be seen in FIG. 11, the injectors 82 are configured to inject the inert gas along directions that form a given angle with the axis of revolution A80 of the annular tube 80. According to this second variant, the streams of inert gas leaving the injectors 82 swirl about the axis of revolution A80 inside the vessel 36, and this contributes to improved venting of the hydrogen in the event of a leak.

According to a configuration that can be seen in FIGS. 12 and 13, the diffuser 78 has a body, of conical overall shape, inside which are arranged fins 90 distributed around the circumference of the body so as to form a turbine for diffusing the inert gas in the vessel 36 by generating a vortex. More specifically, the inert gas coming from the inert gas tank 64 via the injection pipe 66 passes through the diffuser 78 while being deflected by the fins 90 and enters the vessel 36 as it swirls. Of course, the invention is not limited to these embodiments for the inert gas injection system 62.

The operating principle of the hydrogen supplying device 26 is as follows:

A leak at an interior zone Zi of one portion 42 causes the level of vacuum to decrease and the pressure to increase in this interior zone Zi. The rate at which the level of vacuum decreases or the pressure increases depends on the magnitude of the leak and/or the volume of the interior zone Zi.

Once the pressure in the interior zone Zi reaches a given threshold, this automatically and autonomously causes a change of state of each autonomous ventilation valve 54 (like a pressure limiting valve, for example) that communicates with said interior zone Zi, which changes to the open state. Consequently, the gas present in the interior zone Zi is vented toward the outer zone Ext of the secondary structure 22. This venting of the hydrogen present in the interior zone Zi makes it possible to reduce the pressure and the concentration of hydrogen in this interior zone Zi and to reduce the pressure until a stabilized pressure less than or equal to the opening pressure of the ventilation valve 54 is obtained.

In parallel or in addition, the presence of hydrogen in the interior zone Zi of a portion 42 is detected by the sensor 38, which transmits a signal to the controller 44, or a signal is transmitted to the controller 44 owing to the autonomous ventilation valve 54 changing to the open state. Upon receiving this signal, the controller 44 causes at least one controllable ventilation valve 56 communicating with said interior zone Zi to change state, switching it to the open state. Consequently, the gas present in the interior zone Zi is vented toward the outer zone Ext of the secondary structure 22.

Once the sensor 38 detects hydrogen in an interior zone Zi of a portion 42 or owing to the autonomous ventilation valve 54 changing to the open state, the controller 44 causes a change of state of the shut-off valves 34, 34′, 34″ provided at each end of the portion 42, which change to the closed state so as to isolate the portion 42 and no longer supply hydrogen to it.

After the shut-off valves 34, 34′, 34″ have closed, the hydrogen no longer being supplied into the interior zone Zi and the ventilation valve 54 venting the hydrogen in said interior zone Zi, the pressure in this interior zone Zi drops to below the opening pressure of the ventilation valve 54. The autonomous ventilation valve 54 will automatically change state from the open position to the closed position, and this transmits a signal to the controller 44. After a time delay, for example ten seconds, the ventilation valve 54 is manually reactivated, i.e., the ventilation valve 54 is forced to change from its closed position to its open position. Upon receiving the signal, the controller 44 then causes at least one valve 88a, 88b to change state so as to activate the inert gas injection system 62 and thus allow the inert gas to enter the vessel 36. Then, the controller 44 causes at least one valve 84a, 84b to change state so as to release the inert gas from the inert gas tank 64. This injection of inert gas into the interior zone Zi promotes the venting of hydrogen toward the outer zone Ext of the secondary structure 22.

The discharge of the hydrogen present in the interior zone Zi can be enhanced by activating the extractor 52.

Like for the prior art, the hydrogen supplying device 26 is configured to isolate a portion 42 from the rest of the hydrogen supplying device 26 once a first hydrogen leak has been detected at said portion 42 so that hydrogen is no longer supplied by virtue of the shut-off valves provided at the ends of the portion 42. This configuration makes it possible to limit the amount of hydrogen present in the interior zone Zi in the event of a leak.

By contrast to the prior art, the hydrogen supplying device 26 is configured to vent the hydrogen present in the interior zone Zi by virtue of the ventilation system 46 in order to reduce the pressure and concentration of hydrogen in the interior zone Zi. Consequently, even if the vessel 36 or the outer pipe 32.2 delimiting the interior zone Zi in which the hydrogen has leaked owing to the first leak is no longer leaktight and leaks, the risks of incidents owing to a second hydrogen leak in the inner zone Int of the secondary structure 22 are virtually zero.

According to a preferred embodiment, the hydrogen supplying device 26 is configured to promote the venting of hydrogen toward the outer zone Ext of the secondary structure 22 by using the injection system 62 to inject an inert gas into the interior zone Zi.

This configuration makes it possible to reduce the concentration of hydrogen in the interior zone Zi even further. Consequently, even if the vessel 36 or the outer pipe 32.2 delimiting the interior zone Zi in which the hydrogen has leaked owing to the first leak is no longer leaktight and leaks, the risks of incidents owing to a second hydrogen leak in the inner zone Int of the secondary structure 22 are reduced even further.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft comprising:
at least one secondary structure separating an inner zone from an outer zone,
at least one motor that uses hydrogen located in the inner zone of the secondary structure,
at least one hydrogen tank, and
at least one hydrogen supplying device connecting the at least one hydrogen tank and the at least one motor, the at least one hydrogen supplying device comprising:
at least one portion having at least one outer enclosure that is at least one outer pipe or at least one vessel,
first and second shut-off valves configured to isolate said at least portion in case of a leak of hydrogen,
at least one inner element, located in the at least one outer enclosure and carrying the hydrogen, the at least one inner element being at least one inner pipe, at least one pump, at least one heat exchanger or at least one shut-off valve, at least one interior zone being located between the inner element and the outer enclosure,
at least one ventilation system configured to vent a gas present in the inner zone toward the outer zone of the at least one secondary structure,
the at least one outer pipe or the at least one vessel delimiting the at least one interior zone and having a cylindrical tubular body, and
at least one injection system for injecting an inert gas into the at least one interior zone, comprising:
one inert gas tank,
one injection pipe connecting the one inert gas tank and the at least one interior zone,
one regulation system for controlling a flow of the inert gas in the one injection pipe, and
one diffuser connected to the one inert gas tank and positioned in the at least one outer pipe or the at least one vessel substantially coaxial with the cylindrical tubular body.

2. The aircraft as claimed in claim 1, wherein the at least one ventilation system comprises at least one ventilation pipe which has at least one inlet leading into the at least one interior zone and an outlet leading into the outer zone of the at least one secondary structure, and at least one ventilation valve configured to occupy an open state, in which the at least one ventilation valve allows a gas to leave the at least one interior zone, and a closed state, in which the at least one ventilation valve prevents a gas from leaving the at least interior zone.

3. The aircraft as claimed in claim 2, wherein the at least one ventilation valve is an autonomous ventilation valve configured to change states autonomously and occupy the closed state when the at least one interior zone exhibits a pressure less than a given threshold and the open state when the at least one interior zone exhibits a pressure greater than or equal to the given threshold.

4. The aircraft as claimed in claim 2, wherein the at least one ventilation valve is a ventilation valve configured to be controlled by a remote element.

5. The aircraft as claimed in claim 4, wherein the at least one hydrogen supplying device further comprises at least one double-wall pipeline having an inner pipe, an outer pipe positioned around the inner pipe and an interior zone located between the inner and outer pipes, and at least one vessel which delimits an interior zone and in which is positioned at least one inner element, and
wherein the at least one ventilation system comprises an inlet, which leads into the interior zone of each double-wall pipeline and at which an autonomous ventilation valve is positioned, and first and second inlets leading into the interior zone of each vessel, an autonomous ventilation valve being positioned at the first inlet, a controllable ventilation valve being positioned at the second inlet.

6. The aircraft as claimed in claim 2, wherein the at least one ventilation system comprises at least one extractor positioned in the at least one ventilation pipe and configured to generate a stream of gas toward the outlet.

7. The aircraft as claimed in claim 1, wherein the one regulation system has at least one controlled valve arranged on an injection circuit and configured to permit a flow of inert gas into the one injection pipe from the one inert gas tank.

8. The aircraft as claimed in claim 1, wherein the one diffuser comprises an annular tube connected to the one inert gas tank and positioned in the vessel substantially coaxial with the cylindrical tubular body and further comprises multiple injectors distributed around a circumference of the annular tube.

9. The aircraft as claimed in claim 8, wherein the annular tube has an axis of revolution and wherein the multiple injectors are configured to inject the inert gas along directions forming a given angle with the axis of revolution of the annular tube so as to obtain a stream swirling around the axis of revolution of the annular tube, inside the vessel.

10. The aircraft as claimed in claim 8, wherein the annular tube has an axis of revolution and wherein the multiple injectors are configured to inject the inert gas along a direction parallel to the axis of revolution of the annular tube.

11. The aircraft as claimed in claim 1, wherein the one diffuser has a body with a conical overall shape, which is connected to the one inert gas tank, is positioned in the vessel and is substantially coaxial with the cylindrical tubular body and further comprising multiple fins distributed around a circumference of the body.

12. The aircraft as claimed in claim 2, wherein the at least one hydrogen supplying device comprises:
at least one pressure relief pipe, which has a first end leading into an inner pipe that carries the hydrogen and a second end leading into the at least one ventilation pipe, and a pressure relief valve positioned at the at least one pressure relief pipe and configured to occupy a closed state when the hydrogen in the inner pipe exhibits a pressure less than or equal to a given threshold and an open state when the hydrogen in the inner pipe exhibits a pressure greater than the given threshold.
